(19) United States
(12) Patent Application Publication
(10) Pub. No.: US 2001/0051870 A1
(43) Pub. Date: Dec. 13, 2001

(54) Pitch changer for audio sound reproduced by frequency axis processing, method thereof and digital signal processor provided with the same

(75) Inventors: Akihiko Okazaki, Yokohama-shi (JP); Yoshinari Ojima, Zama-shi (JP); Jun Wakasugi, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Kawasaki-shi (JP)

(21) Appl. No.: 09/878,383

(22) Filed: Jun. 12, 2001

(30) Foreign Application Priority Data
Jun. 12, 2000 (JP) P2000-175065

(51) Int. Cl. G10L 11/04; G10L 21/00

(52) U.S. Cl. 704/207

(57) ABSTRACT

The present invention discloses reproduction pitch change technology incorporated in audio reproduction system capable of changing reproduction pitch or reproduction time of reproduced sound without causing enlargement of the configuration of the system and complicatedness of its processing and damaging the quality of the reproduced sound. When inputted audio data is converted inversely from frequency region to time region the spectrum of the inputted audio data is shifted on the frequency axis based on a reproduction pitch changing amount and a band width of the audio data after the shift is matched to the band width of the inputted audio data before the shift to obtain a reproduction frequency of the time-series audio data to be outputted. Then,by interpolating or decimating audio data with respect to the spectrum of the audio data shifted on the frequency axis, the numbers of samples of the audio data in the spectrum on the frequency axis before and after the shift are equalized in the same band widths before and after the shift.

### BACKGROUND OF THE INVENTION

1. Field of the Invention

The present invention relates to a pitch changer f or audio sound reproduced by frequency axis processing, a method thereof and a digital signal processor provided with the same. More particularly the present invention relates to an audio reproduction system for reproducing an inputted signal which is not time-series data but frequency data, in which the reproduction pitch of the sound or the reproduction speed can be changed easily by processing the spectrum of audio data compressed as frequency data.

2. Description of the Background Art

Pitch change technology f or use in reproducing audio data has been in demand in various fields such as pitch change effector for recording, apparatus for changing performance time in creating commercial film and the like, talk speed changer for conference recording, interviews, news program and the like, and pitch controllers for Karaoke and the like.

Conventionally, methods for changing the pitch of audio data are divided into (i) processing in time region and (ii) processing in frequency region.

When processing in the time region (i), the wave on the time axis is discontinuous, so that a noise that grates on the ears occurs upon sound reproduction. On the other hand, when processing in the frequency region (ii), such discontinuous points do not occur, so that no noise is generated. However, audio sound is recorded as time-series data in a recording medium such as recording tape and a CD. For this reason, in order to change the pitch to the frequency region, it is necessary to carry out time-to-frequency conversion processing such as FFT (Fast Fourier Transformation) prior to the pitch change processing. Because this FFT requires a very large number of execution steps of arithmetic operations, the processing capacity of the arithmetic operation circuit needs to be sufficiently large, which is a disadvantageous point of this processing.

(1) Next, the reproduction pitch change will be described in detail. The pitch change method is classified as time region data processing method (i) and frequency region data processing method (ii) method, as described above. The former method has been mainly used in simple systems for the key control of Karaoke, while the latter method has been used in systems that demand strict sound quality of a musical instrument.

FIGS. 1A, 1B and 1C show an example of pitch change by time region processing of the above-described (i). When processing in time region, raising/lowering of the pitch is realized by controlling the reproduction speed of the time-series data. Therefore, it should be noted that if raising or lowering of the pitch is done at the same time, the reproduction time is reduced or prolonged.

However, in order to change only the pitch while keeping the reproduction time the same, the reproduction time of the time-series data after the pitch change has to be the same as that of its original time-series data.

Thus, if the pitch of the original data is lowered as shown in FIG. 1B, an overlapping section always appears. On the other hand, if the pitch of the original data is raised as shown in FIG. 1C, data missing section is always generated. Both in cases of FIG. 1B and FIG. 1C, discontinuity occurs in the time series data, so that if audio sound reproduction is executed without any treatment, noise occurs, thereby damaging sound quality.

As technology for avoiding such a defect, so-called cross fade processing shown in FIGS. 2A and 2B is available. In this cross fade processing, as shown in FIG. 2A, when the pitch is lowered, overlapping data at the termination of a continuous waveform is faded out and at the same time, overlapping data at the start of the next continuous waveform is faded in. Consequently, noise at a joint point is reduced. On the other hand, if the pitch is raised as shown in FIG. 2B, the same data is reproduced twice to supplement a missing data sections and cross fade continuous processing is carried out as above, so that noise at joint points is reduced.

However, the cross fade processing may not obtain a favorable effect if the phases of fade-out sound and fade-in sound are opposite to each other. A fact that periodic waviness occurs in reproduced sound has been considered to be a problem.

FIGS. 3A, 3B and 3C show an example of pitch change in the frequency region processing of the above-described (ii).

According to this method, as shown in FIGS. 3B-3A or 3B-3C, the pitch can be changed easily by shifting data on the frequency axis and further, no discontinuous points occur on the time axis. Thus, a feature of this method is that the reproduced sound is excellent quality than in the case of (i).

However, because audio data outputted from a tape, a CD or the like is time-series data, arithmetic operation processing such as FFT is necessary to convert this audio data from time region to frequency region. Although this arithmetic operation processing can be carried out with an apparatus or system such as DSP (Digital Signal Processor) comprised of mainly an arithmetic operating circuit and memory, the processing capacity of the arithmetic operating circuit needs to be sufficient in order to carry out a large number of operations.

(2) Next, time conversion technology for changing the reproduction time (reproduction speed) of audio data will be described.

Executing only reduction or prolongation of the reproduction time without changing the pitch of the reproduced sound is called time stretch or time compression and is mainly employed in talk conversion and apparatus such as a sampler. This can be achieved by applying the above-described pitch change technology.

If the reproduction time is prolonged by slowing the reproduction speed by rotating the tape at a low speed or reading a CD slowly as shown in FIG. 4, the pitch of the reproduced sound drops for the above-described reason. Thus, the time-series data whose pitch has been lowered is then processed to return it to its original pitch using the pitch conversion technology described in the above (1). Consequently, the reproduction time can be prolonged with the pitch kept as it is, as shown in FIG. 4. On the other hand, to reduce the reproduction time, a reverse processing to FIG. 4 has to be carried out.

Conventionally, in cases of carrying out time stretch and time compression by reproducing from a medium which records time-series data such as CDs or music tapes, the reading speed of the medium is made variable using an apparatus for controlling the reproduction speed or otherwise keeping the reproduction speed as it is and the reproduction time is adjusted by providing the system with a large buffer memory. However, both the cases require complicated configurations or large scale processing, so that they cannot be easily achieved.

As described above, of the conventional conversion methods of change the reproduction pitch of audio data, in the case of processing in time region (i), it is difficult to remove noise from reproduced sound completely despite cross fade processing for avoiding discontinuity in audio data being carried out, thereby causing such defects as deterioration of the sound quality. On the other hand, when processing in frequency processing (ii), pre-processing to convert audio data from the time region to the frequency region is necessary, which presents the problem or requiring large scale configuration and a considerable amount of time.

### SUMMARY OF THE INVENTION

An object of the present invention is to provide an audio sound pitch changer by frequency axis processing, capable of easily carrying out changes in the reproduction pitch of audio sound or in reproduction time (reproduction speed) by shift processing of the spectrum of audio data compressed as frequency data, without requiring configuration enlargement, complicated processing or damaging the reproduced sound quality, a method therefore and a digital signal processor provided with these.

According to one aspect of the present invention, there is provided a pitch incorporated in audio reproduction system for changing the reproduction pitch of audio data, comprising: inverse conversion unit which converts input audio data from frequency region to time region inversely to obtain time-series audio data and changes a reproduction pitch of said input audio data; and audio data output unit which outputs audio data of which reproduction pitch is changed by said inverse conversion unit, wherein said inverse conversion unit includes: frequency shift unit which shifts the spectrum of said input audio data on the frequency axis based on a predetermined reproduction pitch changing amount of said input audio data and matches the band width of audio data after shift to the band width of said input audio data before the shift to obtain a reproduction frequency of time-series audio data to be outputted; and audio data interpolation unit which equalizes the numbers of samples of audio data in the spectrum on the frequency axis before and after the shift in the same band width before and after the shift, by interpolating or decimating audio data in the spectrum of the audio data shifted on the frequency axis by said frequency shift unit, said inverse conversion unit, by converting audio data interpolated or decimated by said audio data interpolation unit to time-series audio data inversely, changing the reproduction pitch of audio data to be outputted based on said predetermined pitch changing amount.

According to one aspect of the present invention, there is provided a reproduction time changer incorporated in audio reproduction system for changing the reproduction time of audio data, comprising: inverse conversion unit which converts input audio data from frequency region to time region inversely to obtain time-series audio data and changes a reproduction pitch of said input audio data; audio data output unit which outputs audio data of which reproduction time is changed; clock frequency changer for changing the frequency of a clock signal based on a predetermined reproduction time changing amount of said input audio data; and clock signal supplying unit for supplying a clock signal changed by said clock frequency changer to at least one or more of said inverse conversion unit and said audio data output unit, wherein said inverse conversion unit includes: frequency shift unit which shifts the spectrum of said input audio data on the frequency axis based on a predetermined reproduction time changing amount of said input audio data and matches the band width of audio data after shift to the band width of said input audio data before the shift to obtain a reproduction frequency of time-series audio data to be outputted; and audio data interpolation unit which equalizes the numbers of samples of audio data in the spectrum on the frequency axis before and after the shift in the same bands width before and after the shift, by interpolating or decimating audio data in the spectrum of the audio data shifted on the frequency axis by said frequency shift unit, said inverse conversion unit, by converting audio data interpolated or decimated by said audio data interpolation unit to time-series audio data inversely, changing the reproduction pitch of audio data to be outputted based on said predetermined pitch changing amount, said audio data output unit prolonging or reducing the reproduction time of audio data of which reproduction pitch is changed based on a changed clock signal supplied from said clock signal supplying unit.

According to another aspect of the present invention, there is provided a digital signal processor incorporated in audio reproduction system for changing the reproduction pitch of audio data, comprising: audio data input unit for inputting audio data compressed as frequency data; inverse conversion unit which converts input audio data from frequency region to time region inversely to obtain time-series audio data and changes a reproduction pitch of said input audio data; and audio data output unit which outputs audio data of which reproduction pitch is changed by said inverse conversion unit, wherein said inverse conversion unit includes: frequency shift unit which shifts the spectrum of said input audio data on the frequency axis based on a predetermined reproduction pitch changing amount of said input audio data and matches the band width of audio data after shift to the band width of said input audio data before the shift to obtain a reproduction frequency of time-series audio data to be outputted; and audio data interpolation unit which equalizes the numbers of samples of audio data in the spectrum on the frequency axis before and after the shift in the same band width before and after the shift, by interpolating or decimating audio data in the spectrum of the audio data shifted on the frequency axis by said frequency shift unit, said inverse conversion unit, by converting audio data interpolated or decimated by said audio data interpolation unit to time-series audio data inversely, changing the reproduction pitch of audio data to be outputted based on said predetermined pitch changing amount.

According to another aspect of the present invention, there is provided a digital signal processor incorporated in audio reproduction system for changing the reproduction time of audio data, comprising: audio data input unit for inputting audio data compressed as frequency data; inverse conversion unit which converts input audio data from frequency region to time region inversely to obtain time-series audio data and changes a reproduction pitch of said input audio data; audio data output unit which outputs audio data of which reproduction time is changed; clock frequency changer for changing the frequency of a clock signal based on a predetermined reproduction time changing amount of said input audio data; and clock signal supplying unit for supplying a clock signal changed by said clock frequency changer to at least one or more of said inverse conversion unit and said audio data output unit, wherein said inverse conversion unit includes: frequency shift unit which shifts the spectrum of said input audio data on the frequency axis based on a predetermined reproduction time changing amount of said input audio data and matches the band width of audio data after shift to the band width of said input audio data before the shift to obtain a reproduction frequency of time-series audio data to be outputted; and audio data interpolation unit which equalizes the numbers of samples of audio data in the spectrum on the frequency axis before and after the shift in the same band width before and after the shift, by interpolating or decimating audio data in the spectrum of the audio data shifted on the frequency axis by said frequency shift unit, said inverse conversion unit, by converting audio data interpolated or decimated by said audio data interpolation unit to time-series audio data inversely, changing the reproduction pitch of audio data to be outputted based on said predetermined pitch changing amount, said audio data output unit prolonging or reducing the reproduction time of audio data of which reproduction pitch is changed based on a changed clock signal supplied from said clock signal supplying unit.

According to another aspect of the present invention, there is provided a computer readable recording medium for causing a computer to execute a processing for changing the reproduction pitch of audio data arbitrarily, the processing comprising: converting input audio data from frequency region to time region inversely to obtain time-series audio data and changing a reproduction pitch of said input audio data; and outputting audio data of which reproduction pitch is changed by said inverse converting processing, wherein said inverse converting processing includes: shifting the spectrum of said input audio data on the frequency axis based on a predetermined reproduction pitch changing amount of said input audio data and matching the band width of audio data after shift to the band width of said input audio data before the shift to obtain a reproduction frequency of time-series audio data to be outputted; and equalizing the numbers of samples of audio data in the spectrum on the frequency axis before and after the shift in the same bands width before and after the shift, by interpolating or decimating audio data in the spectrum of the audio data shifted on the frequency axis by said frequency shift processing, said inverse converting processing, by converting audio data interpolated or decimated by said audio data interpolating processing to time-series audio data inversely, changing the reproduction pitch of audio data to be outputted based on said predetermined pitch changing amount.

According to another aspect of the present invention, there is provided a computer readable recording medium for causing a computer to execute a processing for changing the reproduction time of audio data arbitrarily, the processing comprising: converting input audio data from frequency region to time region inversely to obtain time-series audio data and changing a reproduction pitch of said input audio data; outputting audio data of which reproduction time is changed; changing the frequency of a clock signal based on a predetermined reproduction time changing amount of said input audio data; and supplying a clock signal changed by said clock frequency changing processing to at least one or more of said inverse converting processing and said audio data output processing, wherein said inverse converting processing includes: shifting the spectrum of said input audio data on the frequency axis based on a predetermined reproduction time changing amount of said input audio data and matching the band width of audio data after shift to the band width of said input audio data before the shift to obtain a reproduction frequency of time-series audio data to be outputted; and equalizing the numbers of samples of audio data in the spectrum on the frequency axis before and after the shift in the same bands width before and after the shift, by interpolating or decimating audio data in the spectrum of the audio data shifted on the frequency axis by said frequency shift processing, said inverse converting processing, by converting audio data interpolated or decimated by said audio data interpolating processing to time-series audio data inversely, changing the reproduction pitch of audio data to be outputted based on said predetermined pitch changing amount, said audio data output processing prolonging or reducing the reproduction time of audio data of which reproduction pitch is changed based on a changed clock signal supplied from said clock signal ,supplying processing.

According to another aspect of the present invention, there is provided a computer program for causing a computer to execute a processing for changing the reproduction pitch of audio data arbitrarily, the processing comprising: converting input audio data from frequency region to time region inversely to obtain time-series audio data and changing a reproduction pitch of said input audio data; and outputting audio data of which reproduction pitch is changed by said inverse converting processing, wherein said inverse converting processing includes: shifting the spectrum of said input audio data on the frequency axis based on a predetermined reproduction pitch changing amount of said input audio data and matching the band width of audio data after shift to the band width of said input audio data before the shift to obtain a reproduction frequency of time-series audio data to be outputted; and equalizing the numbers of samples of audio data in the spectrum on the frequency axis before and after the shift in the same bands width before and after the shift, by interpolating or decimating audio data in the spectrum of the audio data shifted on the frequency axis by said frequency shift processing, said inverse converting processing, by converting audio data interpolated or decimated by said audio data interpolating processing to time-series audio data inversely, changing the reproduction pitch of audio data to be outputted based on said predetermined pitch changing amount.

According to another aspect of the present invention, there is provided a computer program for causing a computer to execute a processing for changing the reproduction time of audio data arbitrarily, the processing comprising: converting input audio data from frequency region to time region inversely so as to obtain time-series audio data and changing a reproduction pitch of said input audio data; outputting audio data whose reproduction time is changed; changing the frequency of a clock signal based on a predetermined reproduction time changing amount of said input audio data; and supplying a clock signal changed by said clock frequency changing processing to at least one or more of said inverse converting processing and said audio data output processing, wherein said inverse converting processing includes: shifting the spectrum of said input audio data on the frequency axis based on a predetermined reproduction time changing amount of said input audio data and matching the band width of audio data after shift to the band width of said input audio data before the shift to obtain a reproduction frequency of time-series audio data to be outputted; and equalizing the numbers of samples of audio data in the spectrum on the frequency axis before and after the shift in the same bands width before and after the shift, by interpolating or decimating audio data in the spectrum of the audio data shifted on the frequency axis by said frequency shift processing, said inverse converting processing, by converting audio data interpolated or decimated by said audio data interpolating processing to time-series audio data inversely, changing the reproduction pitch of audio data to be outputted based on said predetermined pitch changing amount, said audio data output processing prolonging or reducing the reproduction time of audio data of which reproduction pitch is changed based on a changed clock signal supplied from said clock signal supplying processing.

According to another aspect of the present invention, there is provided a method of changing the reproduction pitch of audio data arbitrarily, comprising: converting input audio data from frequency region to time region inversely to obtain time-series audio data and changing a reproduction pitch of said input audio data; and outputting audio data of which reproduction pitch is changed by said inverse converting step, wherein said inverse converting step includes: shifting the spectrum of said input audio data on the frequency axis based on a predetermined reproduction pitch changing amount of said input audio data and matching the band width of audio data after shift to the band width of said input audio data before the shift to obtain a reproduction frequency of time-series audio data tone outputted; and equalizing the numbers of samples of audio data in the spectrum on the frequency axis before and after the shift in the same bands width before and after the shift, by interpolating or decimating audio data in the spectrum of the audio data shifted on the frequency axis by said frequency shift step, said inverse converting step, by converting audio data interpolated or decimated by said audio data interpolating step to time-series audio data inversely, changing the reproduction pitch of audio data to be outputted based on said predetermined pitch changing amount.

According to another aspect of the present invention, there is provided a method of changing the reproduction time of audio data arbitrarily, comprising: converting input audio data from frequency region to time region inversely to obtain time-series audio data and changing a reproduction pitch of said input audio data; outputting audio data of which reproduction time is changed; changing the frequency of a clock signal based on a predetermined reproduction time changing amount of said input audio data; and supplying a clock signal changed by said clock frequency changing step to at least one or more of said inverse converting step and said audio data output step, wherein said inverse converting step includes: shifting the spectrum of said input audio data on the frequency axis based on a predetermined reproduction time changing amount of said input audio data and matching the band width of audio data after shift to the band width of said input audio data before the shift to obtain a reproduction frequency of time-series audio data to be outputted; and equalizing the numbers of samples of audio data in the spectrum on the frequency axis before and after the shift in the same bands width before and after the shift, by interpolating or decimating audio data in the spectrum of the audio data shifted on the frequency axis by said frequency shift step, said inverse converting step, by converting audio data interpolated or decimated by said audio data interpolating step to time-series audio data inversely, changing the reproduction pitch of audio data to be outputted based on said predetermined pitch changing amount, said audio output processing prolonging or reducing the reproduction time of audio data of which reproduction pitch is changed based on a changed clock signal supplied from said clock signal supplying step.

Other features and advantages of the present invention will become apparent from the following description taken in conjunction with the accompanying drawings.

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIGS. 1A, 1B and 1C are diagrams f or explaining an example of changing pitch of audio data by time axis processing based on a conventional technology;

FIGS. 2A and 2B are diagrams for explaining an example of cross fade processing carried out in the pitch change processing shown in FIGS. 1A, 1B and 1C;

FIGS. 3A, 3B and 3C are diagrams for explaining an example of changing the pitch of audio data by frequency axis processing based on conventional technology;

FIG. 4 is a diagram for explaining an example of reproduction time changing of audio data by time stretch based on the conventional technology;

FIG. 5 is a block diagram showing the structure of MP3 encoder/decoder containing the function of the reproduction pitch changer according to a first embodiment of the present invention;

FIG. 6 is a diagram showing an example of a audio sound sine wave data in a frequency region;

FIG. 7 is a diagram showing output audio signal corresponding to sine wave data of FIG. 2;

FIG. 8 is a diagram showing sine wave data in which the frequency of FIG. 6 is shifted to twice its original frequency;

FIG. 9 is sine wave data in which the number of samples is doubled by interpolating the sine wave data of FIG. 8;

FIG. 10 is a diagram showing output audio signal in which audio signal of FIG. 7 is pitched up;

FIG. 11 is a diagram showing sine wave data in which the frequency of FIG. 6 is shifted to ½ its original frequency;

FIG. 12 is a diagram showing sine wave data in which the number of samples is reduced by ½ by decimating the sine wave data;

FIG. 13 is a diagram showing output audio signal obtained by pitching down the audio signal of FIG. 7;

FIG. 14 is a block diagram showing the structure of an audio reproduction system incorporated in a MP3 encoder/decoder containing the function of the reproduction time changer according to a second embodiment of the present invention;

FIG. 15 is a diagram showing output audio signal in which the audio signal of FIG. 7 is time-stretched; and

FIG. 16 is a diagram showing output audio signal in which the audio signal of FIG. 7 is time-compressed.

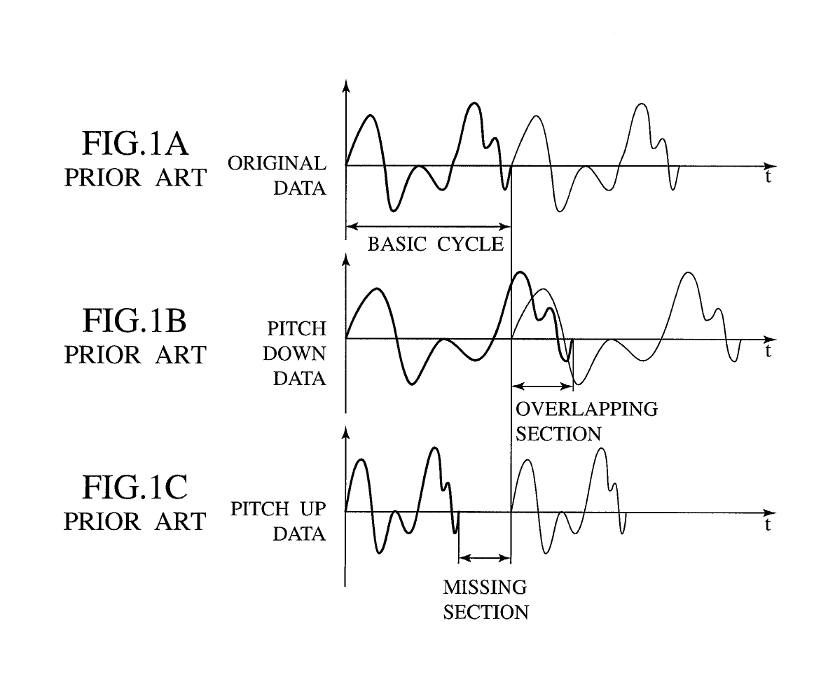

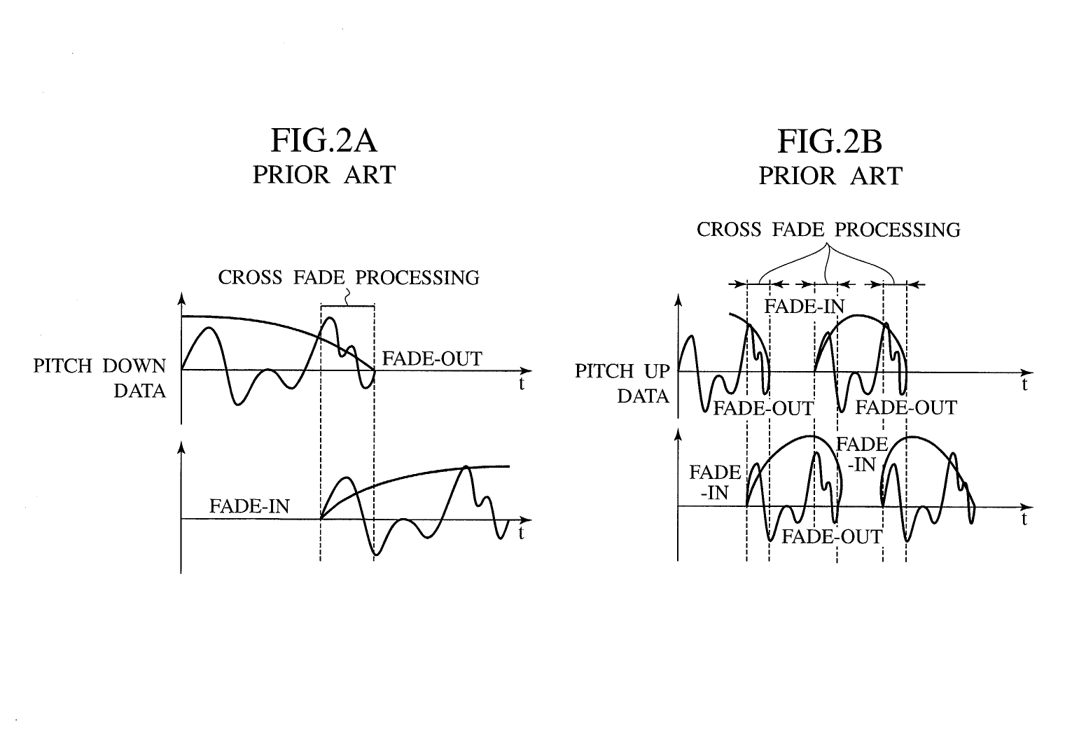

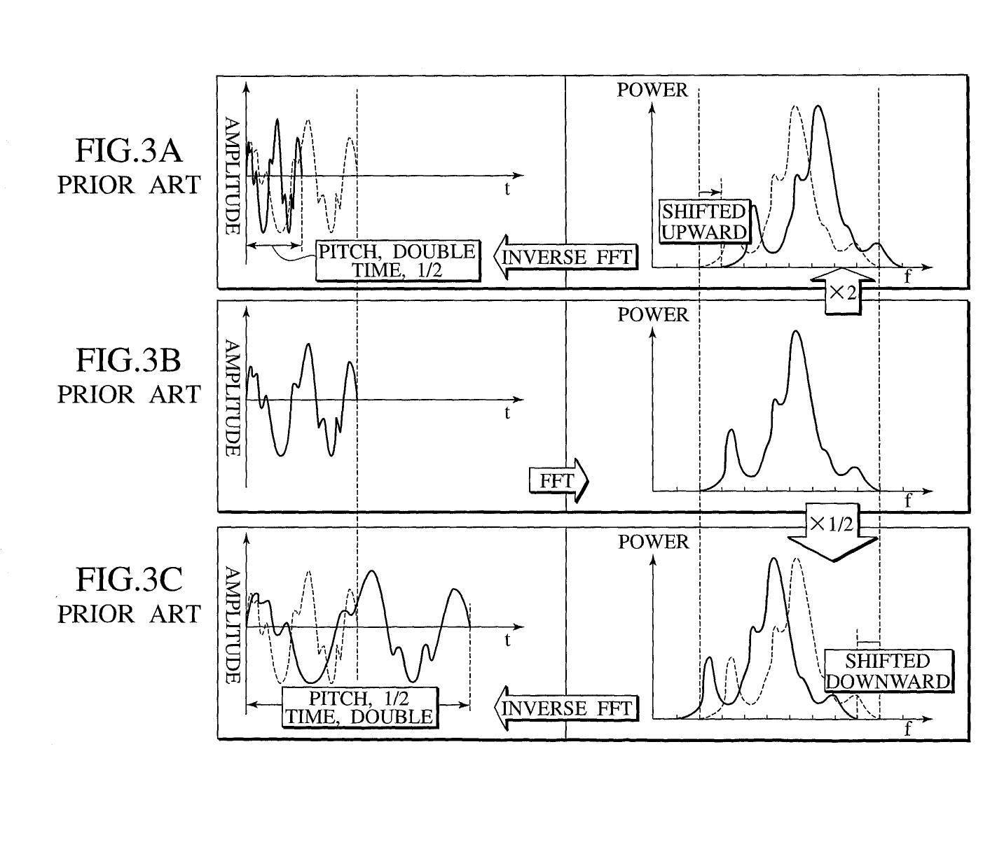

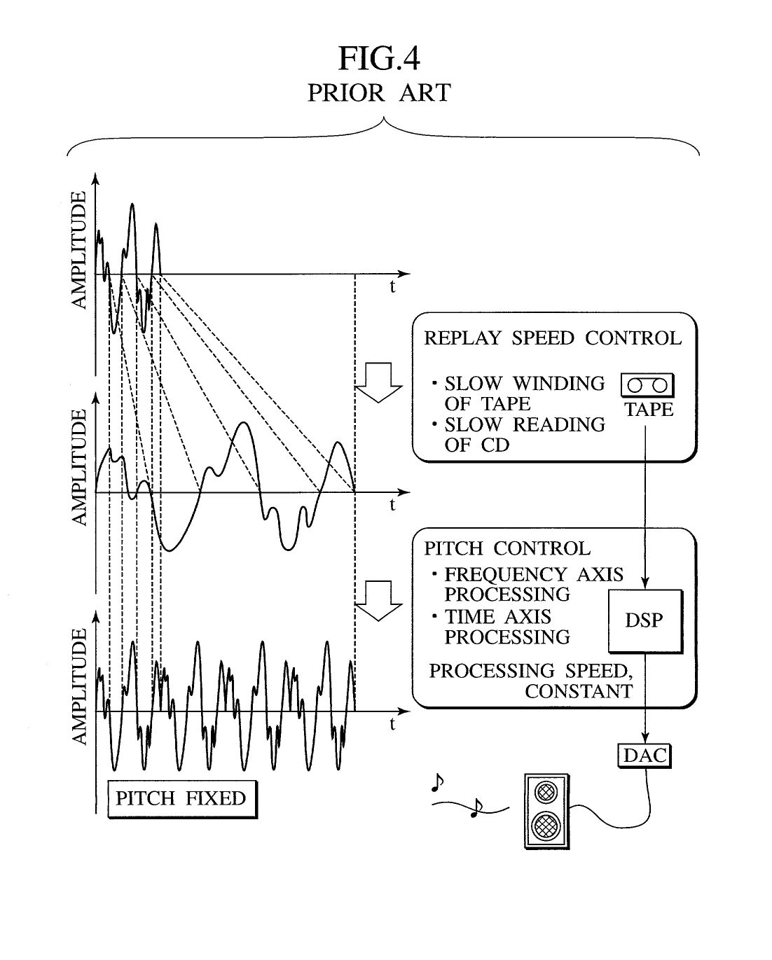

### DETAILED DESCRIPTION OF THE PREFERRED EMBODIMENTS

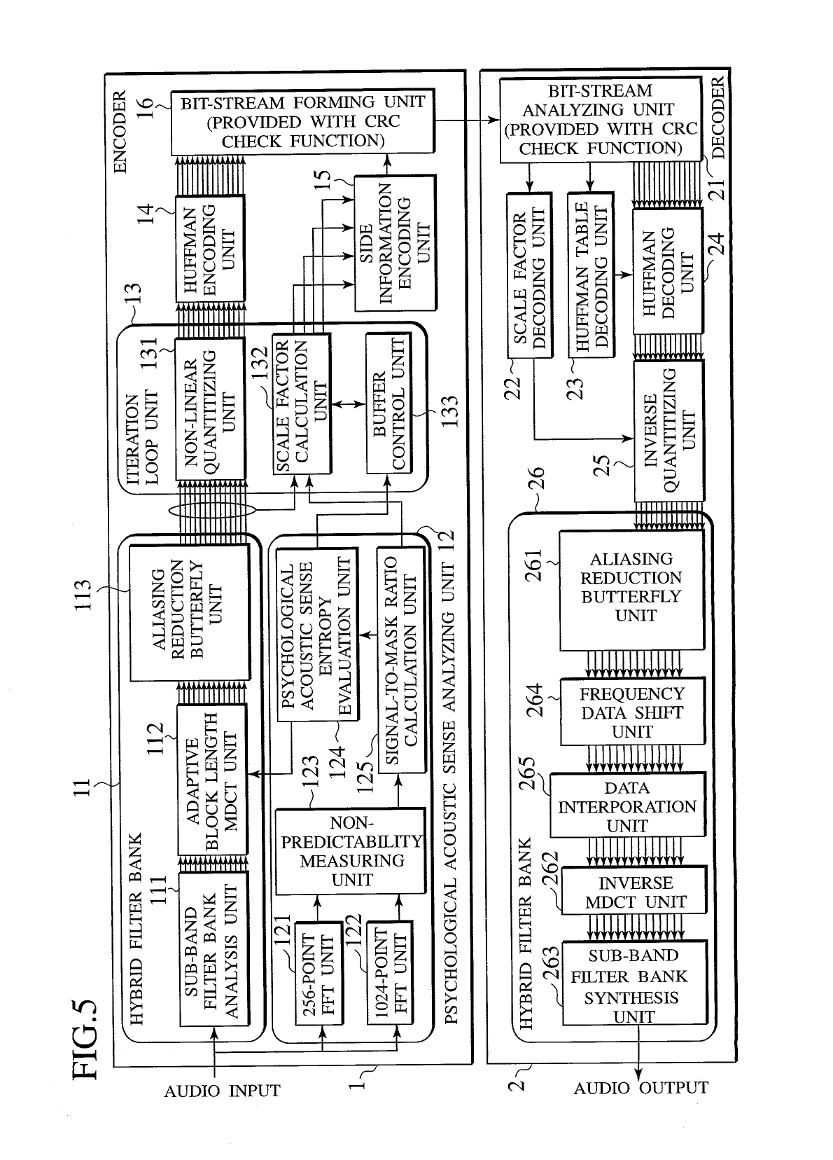

Hereinafter, the preferred embodiment of the frequency axis processing type reproduction pitch conversion unit, method therefore, digital signal processor provided with these and audio reproduction system according to the present invention will be described in detail with reference to FIGS. 5 to 16.

First embodiment

Hereinafter, the first embodiment of the present invention will be described in detail with reference to FIGS. 5 to 13.

The first embodiment provides a simple reproduction pitch change function in audio sound reproduction by manipulating spectrum information on the frequency axis.

FIG. 5 shows the structure of the MP3 encoder/decoder containing the reproduction pitch changer according to the first embodiment of the present invention.

In the first embodiment, an example of pitch change upon reproducing compressed sound, compressed according to the MP3 system, which is one of the MPEG audio compression system, will be described. Because the first embodiment can be applied to all kinds of input audio data if they are frequency data, it can be carried out for the MPEG audio compression type such as MP3. Further, the audio compression is not restricted to particularly the MPEG system, but can be carried out in, for example, AAC (Advanced Audio Coding) system.

Because the compressed audio data compressed by the MPEG system has been already recorded in the form of frequency data, it does not have to be subjected to frequency-to-time conversion unlike case of reproduction of time-series data recorded in a medium. According to the first embodiment of the present invention, this point is used, so that by the addition of programs of only a few steps to software for executing algorithm in filter calculation processing without much changing the filter operation processing carried out when decoding compressed MPEG audio data, the spectrum information in the frequency region can be manipulated to achieve the pitch change of reproduced sound easily.

Referring to FIG. 5, the MP3 encoder and decoder of the first embodiment comprises an encoder 1 which receives input audio data which is a time-series data and converts and compresses this audio data to data in the frequency region according to the MP3 compression system which is well known conventionally, and a decoder 2 which receives an output data (frequency data) in the frequency region of this encoder 1, converts this output frequency data to time-series data inversely and outputs audio data of time series data.

The encoder 1 comprises a hybrid filter bank 11, a psychological acoustic sense analyzing unit 12, a repeating loop 13, a Huffman encoding unit 14, a side information encoding unit 15 and a bit-stream forming unit 16 provided with CRC check function.

The hybrid filter bank 11 comprises a sub-band filter bank analysis unit 111 for dividing the frequency band to 32 sectors, an adaptive block length MDCT (Modified Discrete Cosine Transform) unit 112 for converting an input signal from time unit to frequency unit and an aliasing reduction butterfly unit 113 for reducing folding distortion by butterfly calculation.

The psychological acoustic sense analyzing unit 12 comprises 256 FFT (Fast Fourier transformation) units 121, 1024 FFT (Fast Fourier transformation) units 122, a non-predictability measuring unit 123, a psychological acoustic sense entropy evaluation unit 124 and a SMR (Signal-to-Mask Ratio) calculation unit 125.

The iteration loop unit 13 comprises a non-linear quantitizing unit 131 for carrying out non-linear quantitization processing following bit allocation based on a psychological acoustic sense model, a scale factor calculation unit 132 and a buffer control unit 133.

The Huffman encoding unit 14 receives an output of the iteration loop unit 13 and carries out Huffman encoding. The Huffman encoding refers to a processing executed by arranging in line in order from a lower frequency.

The side information encoding unit 15 receives an output of the iteration loop unit 13 and encodes side information. The side information refers to bit allocation information which is determined using SMR (Signal-to-Mask Ratio) obtained by the psychological acoustic sense analyzing unit 12.

The bit-stream forming unit 16 forms a bit stream by receiving an output of the Huffman encoding unit 14 and an output of the side information encoding unit 15. The bit-stream forming unit 16 may be provided with CRC check function.

To allocate bits for non-linear quantitization, the encoder 1 calculates a masking level of quantitization error based on psychological acoustic sense model by using 16-bit linear quantitized PCM (Pulse Code Modulation) input signal. At this time, the block length of the MDCT is determined based on psychological acoustic sense entropy using prediction impossibility (non predictability).

On the other hand, the 16-bit linear quantitized PCM input signal is mapped to frequency region (for example, 32)from time region in PFB (Polyphase Filler Bank), then respective band is mapped to the spectrum line in the adaptive block length MDCT section more minutely. The adaptive block length MDCT unit aims at restricting pre-echo. As the block length, for example, 18 or 6×3, which is determined based on the psychological acoustic sense model. After the folding distortion cut-off butterfly calculation is completed, an obtained map signal is made non-linear following the bit allocation based on the psychological acoustic sense model.

Quantitization is accompanied with folding loop and bit distribution exceeding a frame border is carried out in time region. After Huffman encoding, the quantitized signal is built into a frame. At this time, bit allocation information is attached as side information.

Next, the decoder 2 comprises a bit-stream analyzing unit 21, a scale factor decoding unit 22, a Huffman table decoding unit 23, a Huffman decoding unit 24, an inverse quantitizing unit 25, a Huffman table decoding unit 23 and a hybrid filter bank 26.

The bit stream analyzing unit 21 receives an output of the bit stream forming unit 16 of the encoder 1 in the frequency region and analyzes a bit stream.

The scale factor decoding unit 22 receives an output of the bit stream analyzing unit 21 and decodes the scale factor.

The Huffman table decoding unit 23 receives an output of the bit stream analyzing unit 21 and carries out the Huffman table decoding.

The Huffman decoding unit 24 receives output from the bit stream analyzing unit 21 and Huffman table decoding unit 23 and carries out Huffman decoding.

The inverse quantitizing unit 25 receives an output of the scale factor decoding unit 23 and Huffman decoding unit 24 and inversely quantitizes so as to obtain spectrum information.

The hybrid filter bank 26 receives an output of the inverse quantitizing unit 25 and reproduces audio data, which is time-series data, and further carries out reproduction pitch change processing according to the first embodiment in this reproduction process.

The hybrid filter bank 26 comprises an aliasing reduction butterfly unit 261 for butterfly calculating spectrum information obtained by the inverse quantitizing unit 25, an inverse MDCT unit 262 which receives an output of the aliasing reduction butterfly unit 261 so as to carry out inverse Fourier transformation from frequency unit to time unit, a sub-band filter bank synthesis unit 263 which receives an output of the inverse MDCT unit 262 and synthesizes, for example, the frequency band divided to 32 sectors, a frequency data shift unit 264 and a data interpolation unit 265.

The frequency data shift unit 264 shifts frequency data on the frequency axis based on reproduction pitch change amount data given from outside. In this specification, the shift includes both multiplication and data shift processing.

The data interpolation unit 265 carries out interpolation or decimation processing on the frequency data shifted by the frequency data shift unit 264. The interpolation mentioned in this specification refers to interpolation or decimation processing.

The decoder 2 disassembles a frame formed by the bit-stream forming unit 16 of the encoder 1 and allocates bits according to received side information and decodes the received data using the Huffman table. Next, Huffman decoding and inverse quantitization are carried out based on this side information. By inversely mapping the inverse quantitization signal by means of the hybrid filter bank 26, time region signal is reproduced.

The hybrid filter bank 26 in the decoder 2 carries out processings of butterfly calculation, inverse MDCT, and QMF (Quadrature Mirror Filter) synthesis. These processings are carried out by software serving as an algorithm. According to this algorithm, to carrying out pitch change processing, the frequency data shift unit 264 shifts spectrum information in the frequency region before carrying out frequency-to-time conversion so as to determine the frequency of reproduced sound. Further, the data interpolation unit 265 carries out data interpolation or decimation processing in the frequency region to the shifted spectrum information, so as to correct the quantity of samples in shifted frequency data. Consequently, the pitch is changed and reproduction time is blocked from being changed when the spectrum information is converted to data in the time region.

Although the shift processing of the spectrum information by the frequency data shift unit 264 is preferred to be carried out by the hybrid filter bank 26 after the butterfly calculation by the aliasing reduction butterfly unit 261 is carried out, it may be carried out prior to butterfly calculation. All or part of the aforementioned algorithm may be formed into a firm ware by being memorized in a ROM preliminarily or loaded in a program memory depending on the necessity as a program code and executed by the CPU.

The decoder 2 (or both the encoder 1 and the decoder 2) composes a DSP (Digital Signal Processor).

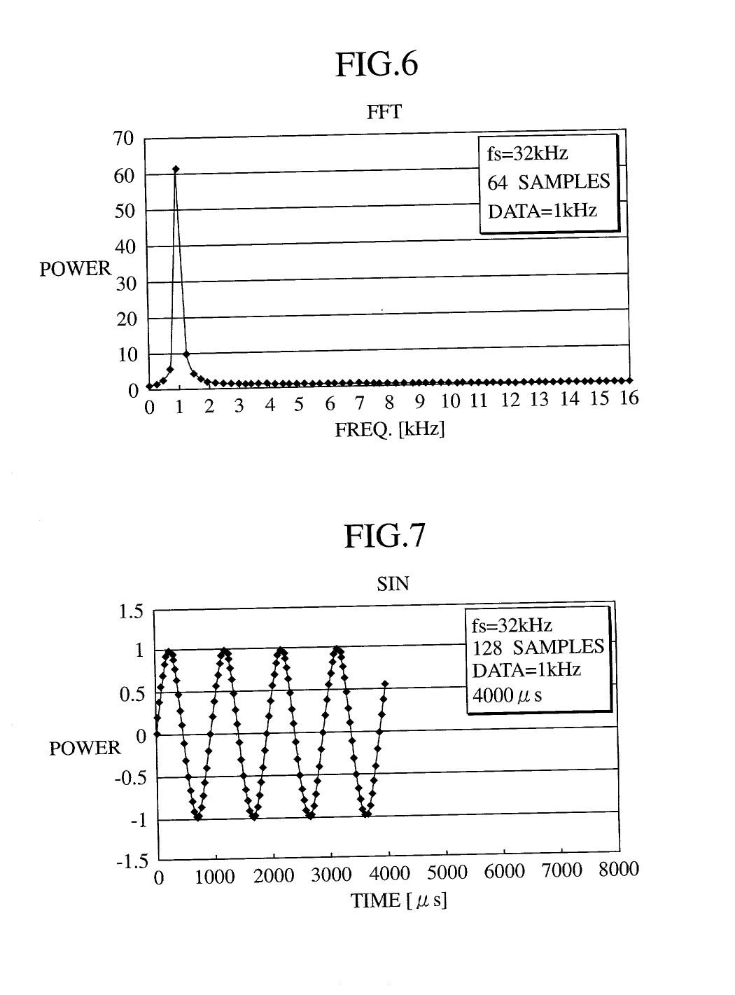

Next, referring to FIGS. 6 to 13, the reproduction pitch change processing according to the first embodiment, which is carried out by the frequency data shift unit 264 and the data interpolation unit 265 will be described. FIG. 6 shows an example of the sine wave data in the frequency region, which is input data in the reproduction pitch change processing described below. FFT/inverse FFT will be described about a result of simulating spectrum information of 0-16 kHz in band. Data to be inputted to the inverse FFT of the decoder 2 has sine wave of 1 kHz, sampling frequency of 32 kHz and sample number of 64.

FIG. 7 shows an output audio signal in case where no pitch change processing is carried out.

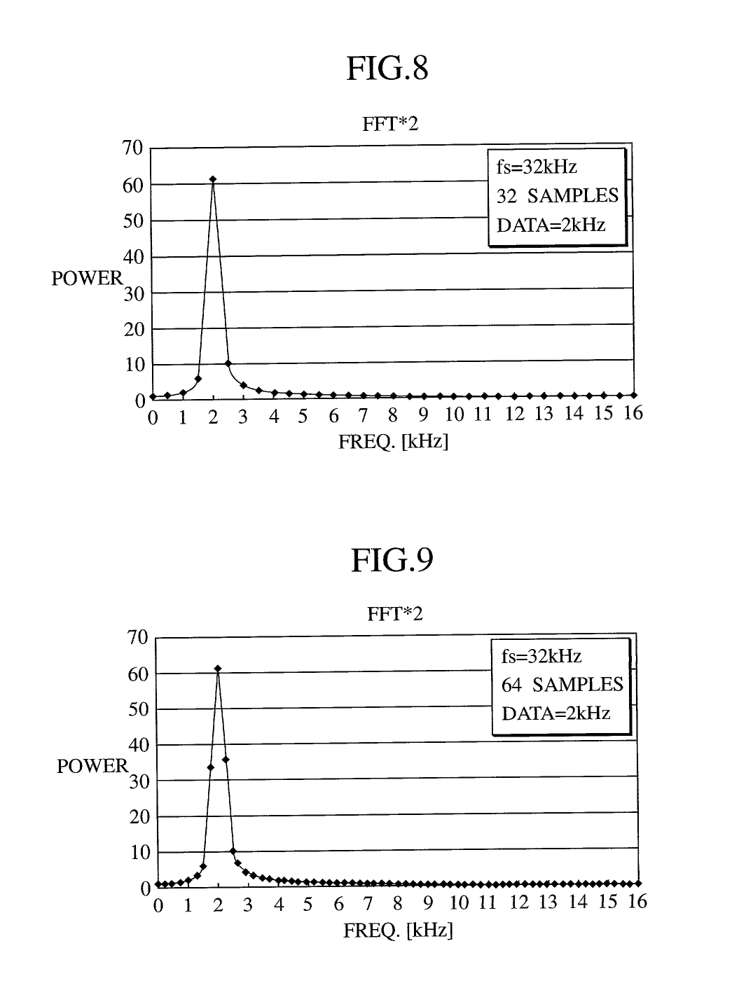

A case of raising the pitch of audio signal to twice will be considered. First, as shown in FIG. 8, the spectrum information is shifted on the frequency axis so as to double its frequency shown in FIG. 6. At this time, the band of the spectrum information is widened from 16 kHz to 32 kHz. Here, the widened band is limited to half, which is 16 kHz and then a subsequent band is deleted. Consequently, the number of data samples in band of 0-16 kHz is decreased from 64 to half, which is 32. Assuming that with this condition, frequency data is converted from frequency region to time region, reproduction time is decreased from 4000μs shown in FIG. 7 to half, which is 2000μs.

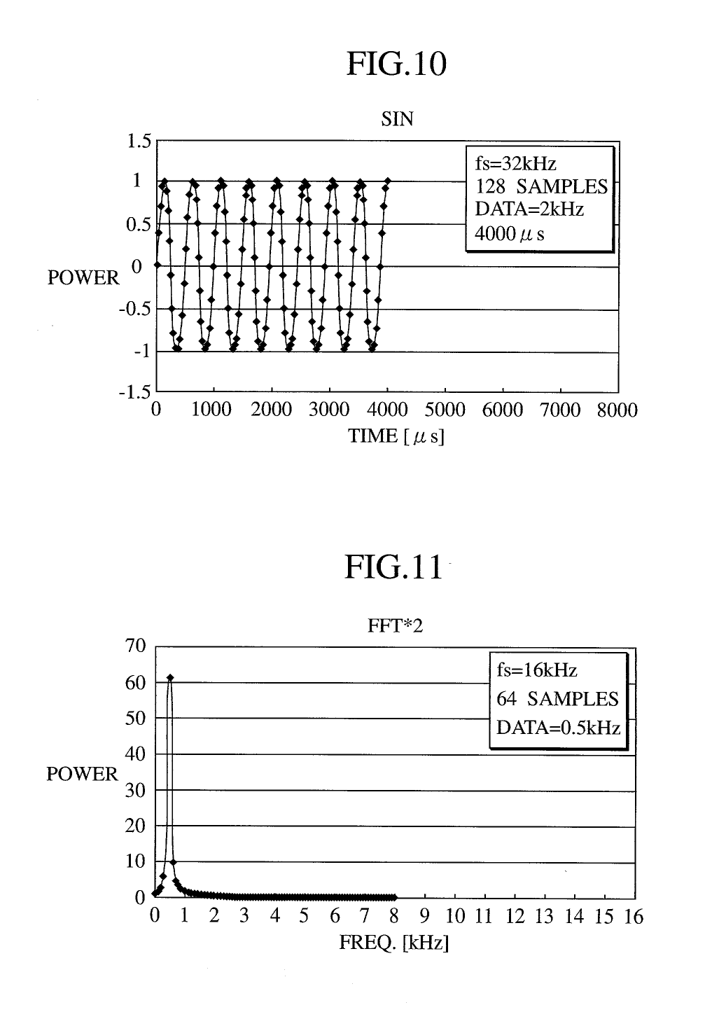

According to the first embodiment, data of the spectrum information shown in FIG. 8 is interpolated to increase the number of data from 32 to 64, which is the same sample number as before the shift as shown in FIG. 9. The interpolation of data with the data interpolation unit 265 may be carried out by primary interpolation method, which adds data at an intermediate point between two data, or by other well-known interpolation method. After the number of samples is increased to 64 by interpolating data, data is converted inversely from the frequency region to the time region. As a result, reproduced data turns to sine wave of 2 kHz in frequency while the reproduction time is kept 4000μs as shown in FIG. 10. That is, the pitch of the sine wave data can be increased to double without changing the reproduction time.

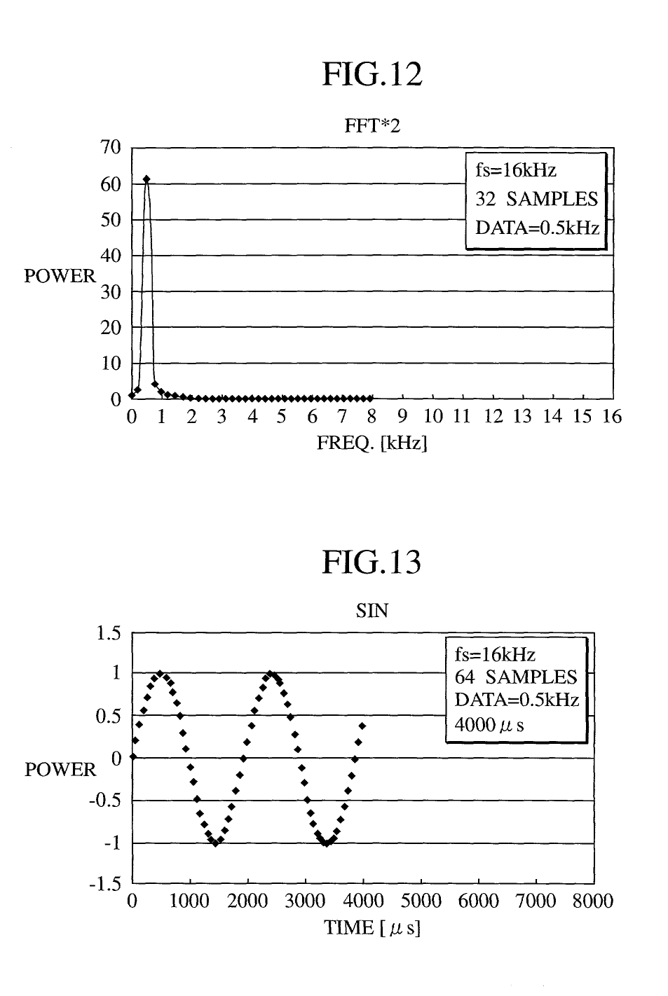

Next, a case of decreasing the pitch of the sine wave data to ½-fold as shown in FIG. 6 will be considered. In this case, the spectrum information shown in FIG.6 is shifted so that the spectrum information turns to ½ in frequency as shown in FIG. 11. Consequently, the band of the spectrum information is reduced from 16 kHz to 8 kHz. If the frequency data is converted from the frequency region to the time region in this time, the reproduction time is increased from 4000μs to 8000μs, which is double. In the first embodiment, data is decimated from the spectrum information shown in FIG. 11, so that the number of data is reduced from 64 to the same number of 32 (band of 0-8 kHz) as before the shift as shown in FIG. 12. The decimation of data is carried out by deleting data at an intermediate point of data, for example. After the number of samples is reduced to 32 by decimating data, the data is converted inversely from the frequency region to the time region. As a result, the reproduced audio data turns to sine wave of 0.5 kHz in frequency while the reproduction time is kept 4000μs. That is, the pitch of the sine wave data can be reduced to ½ without changing the reproduction time.

As described above, according to the first embodiment, only by adding processing of several steps in software such as frequency shift and data interpolation/decimation to a process for converting data from frequency region to time region, the pitch of the reproduced sound can be made variable arbitrarily easily, because the processing in the frequency region in which noise is smaller and the accuracy is higher than the processing in the time region is executed by using input audio data recorded in a recording medium such as MP3 and AAC as the frequency data.

Because data in the unit of frequency is outputted from a compression storage medium in which compressed data such as MP3, AAC, use of this eliminates application load on an arithmetic operation unit in a large scale processing of converting data from time region to frequency region compared to the recording medium such as a tape and a CD. Further, data in the time region is not utilized as it is, so that no noise is generated in the reproduced sound.

Second embodiment

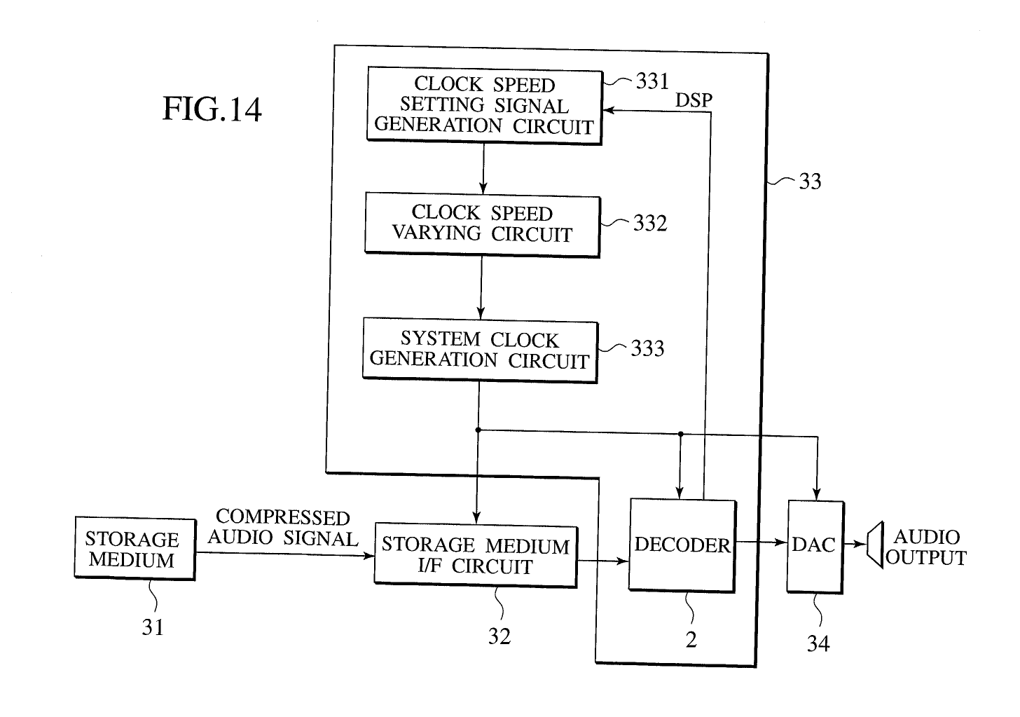

Next, the second embodiment of the present invention will be described about only different points from the first embodiment with reference to FIGS. 14 to 16.

The second embodiment provides a time stretch/compression function while keeping the reproduction pitch invariable by controlling clock speed of DSP (Digital Signal Processor) by applying the reproduction pitch conversion processing of the first embodiment.

FIG. 14 is a diagram showing the structure of a audio data reproduction system including the function of the time and pitch changer according to the second embodiment.

Referring to FIG. 14, the audio data reproduction system comprises a storage medium 31 for outputting a compressed audio signal, a storage medium I/F circuit 32 for receiving a compressed audio signal outputted from this storage medium 31, aDSP (Digital Signal Processor) 33 and a DAC (Digital Analog Converter) 34 for converting a digital signal outputted from the DSP 33 to an analog signal.

In addition to the decoder 2 (or both the encoder 1 and the decoder 2), shown in FIG. 5, the DSP 33 according to the second embodiment comprises a clock speed setting signal generating circuit 331 for generating a clock speed setting signal corresponding to a reproduction time of audio data to be reproduced, a clock speed varying circuit 332 for changing an original clock signal on receiving the clock speed setting signal and a system clock generating circuit 333 for generating a clock signal of the system on receiving an output of the clock speed varying circuit 32.

In the audio data reproduction system having the structure shown in FIG. 5, the reading speed is arbitrary because a source for reading the audio data is the storage medium 31. On the other hand, only if a MIPS value (Million Instructions Per Second: processing capacity per unit time) necessary for decoding of read data is satisfied, the system clock of the DSP 33 can be set up freely.

In a system intended for only reproduction of audio data consists of only the configuration shown in FIG. 14, any clock of a determined frequency such as sampling frequency does not have to be sent to other circuit. Therefore, the system clock of the DAC 34 can be determined freely. That is, there is not any problem even if the system clock of the system shown in FIG. 14 is made variable as long as a reproduced sound is not affected. Further, the system clock may be made variable easily.

According to the second embodiment of the present invention, using this feature, only the reproduction time is converted without changing the pitch of the reproduced sound by first changing the pitch of the audio data by means of the first embodiment and then making the system clock of the entire system including the DAC 34 variable.

Next, processing procedure of such reproduction time change processing will be described.

(1) Extension of the reproduction time (time stretch)

First, the time stretch will be described.

The clock speed setting signal generating circuit 331 generates a clock speed setting signal corresponding to a reproduction time of audio data to be reproduced. For example, the system clock is set up to be ½ the normal operation time. The clock speed varying circuit 332 sets up the system clock to be ½ the normal operation time in the system clock generating circuit 36, based on the clock speed setting signal.

Making the clock of the entire system variable can be carried out easily by devising a dividing circuit, for example. Although the MIPS value of the DSP 33 is reduced to half by reducing the system clock to ½, it raises no problem unless decoding of input data gets into trouble. The hybrid filter bank 26 is instructed to process data shown in FIGS. 6 and 7 according to the method explained in the first embodiment and when converting data from the frequency region to the time region inversely, the pitch of data is raised to double.

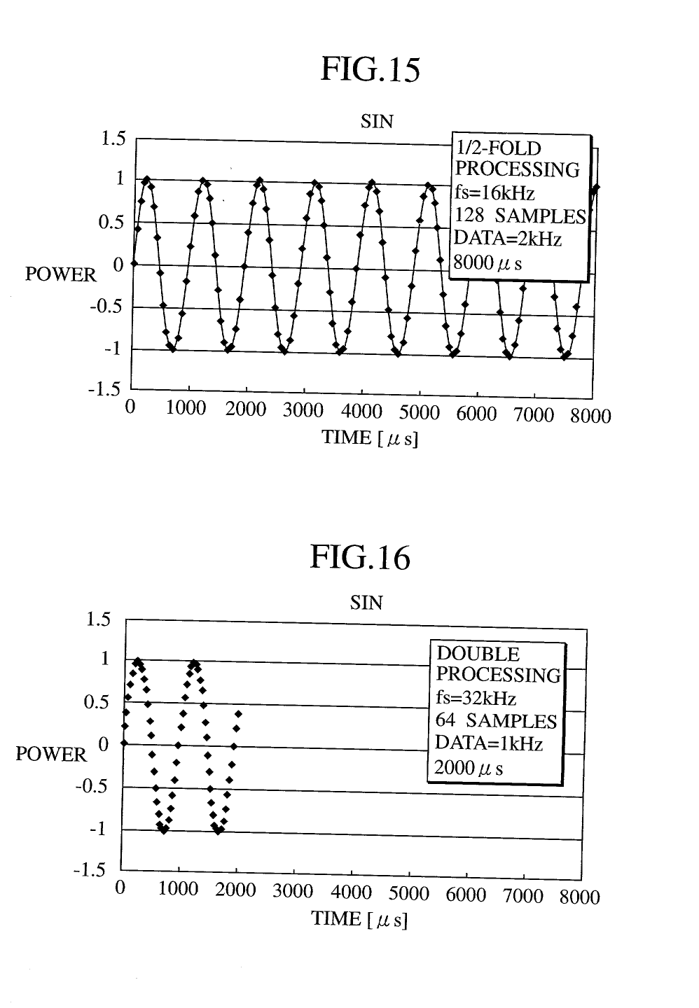

On the other hand, because the system clock to be given to the DAC 34 is ½ the normal operation time, the pitch of a reproduced sound obtained by reverse conversion becomes the same as its original, as shown in FIG. 15, so that the reproduction time is expanded by double.

(2) Reduction of reproduction time (time compression)

On the other hand, in case of time compression, the inverse Processing is carried out compared to the above-described time stretch processing.

The clock speed-setting signal generating unit 331 generates a clock speed setting signal corresponding to the reproduction time of audio data to be reproduced. For example, the system clock is set up to be double the normal operation time. The clock speed varying circuit 332 sets up such that the system clock generating circuit 36 changes the system clock to double the normal operation time based on the clock speed setting signal.

Next, When inversely converting data shown in FIGS. 6 and 7 from frequency region to time region by operating the hybrid filter bank 26 according to the method described in the first embodiment, the pitch of data is reduced by ½.

On the other hand, because the system clock to be given to the DAC 34 is double the normal operation time, as shown in FIG. 16, the pitch of reproduced sound obtained by inverse conversion becomes the same as its original one and further the reproduction time is reduced to ½-fold.

In an audio reproduction system containing the DAC 34, only by adding a simple system clock varying circuit to the configuration of the first embodiment, time stretch and compression operation can be achieved easily without requiring the addition of a reading speed control unit or a large buffer memory and memory management unit unlike conventionally. That is, in the audio reproduction system which comprises the arithmetic operation circuit and DAC driven by the same system clock, by changing the operating clock in the configuration of the previously described embodiment, based on a fact that the system clock can be changed to any speed by aiming at only reproduction of audio data, the time stretch and compression function in which only the reproduction time is prolonged or reduced while reproduction pitch is kept fixed can be achieved easily.

In summary, according to the present invention, by interpolating and decimating data after the spectrum of audio data compressed as the frequency data is shifted, time-series data is inversely converted to audio data. Therefore, the pitch of the reproduced sound can be changed easily without changing the reproduction time. Further, because according to the present invention, the frequency of the operating clock signal when converting digital audio signal to analog audio signal is changed corresponding to the desired reproduction time in addition to the processing of the above-described inverse conversion, the reproduction time of the reproduced sound can be prolonged or reduced without changing the pitch.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A pitch changer incorporated in audio reproduction system for changing the reproduction pitch of audio data, comprising:
inverse conversion unit which converts input audio data from frequency region to time region inversely to obtain time-series audio data and changes a reproduction pitch of said input audio data; and
audio data output unit which outputs audio data of which reproduction pitch is changed by said inverse conversion unit,
wherein said inverse conversion unit includes:
frequency shift unit which shifts the spectrum of said input audio data on the frequency axis based on a predetermined reproduction pitch changing amount of said input audio data and matches the band width of audio data after shift to the band width of said input audio data before the shift to obtain a reproduction frequency of time-series audio data to be outputted; and
audio data interpolation unit which equalizes the numbers of samples of audio data in the spectrum on the frequency axis before and after the shift in the same band width before and after the shift, by interpolating or decimating audio data in the spectrum of the audio data shifted on the frequency axis by said frequency shift unit,
said inverse conversion unit, by converting audio data interpolated or decimated by said audio data interpolation unit to time-series audio data inversely, changing the reproduction pitch of audio data to be outputted based on said predetermined pitch changing amount.

2. The pitch changer according to claim 1, further comprising:
DAC (Digital Analog Converter) for converting digital audio data of time-series data obtained by said inverse conversion unit to analog audio data,
wherein said audio output unit outputs analog audio data obtained by conversion by said DAC.

3. The pitch changer according to claim 1, wherein
said input audio data is compressed and stored as frequency data in a storage medium from which data can be read at any data reading speed.

4. The pitch changer according to claim 1, wherein
said inverse conversion unit converts the reproduction pitch without changing the reproduction speed of the audio data to be outputted.

5. A reproduction time changer incorporated in audio reproduction system for changing the reproduction time of audio data, comprising:
inverse conversion unit which converts input audio data from frequency region to time region inversely to obtain time-series audio data and changes a reproduction pitch of said input audio data;
audio data output unit which outputs audio data of which reproduction time is changed;
clock frequency changer for changing the frequency of a clock signal based on a predetermined reproduction time changing amount of said input audio data; and
clock signal supplying unit for supplying a clock signal changed by said clock frequency changer to at least one or more of said inverse conversion unit and said audio data output unit,
wherein said inverse conversion unit includes:
frequency shift unit which shifts the spectrum of said input audio data on the frequency axis based on a predetermined reproduction time changing amount of said input audio data and matches the band width of audio data after shift to the band width of said input audio data before the shift to obtain a reproduction frequency of time-series audio data to be outputted; and
audio data interpolation unit which equalizes the numbers of samples of audio data in the spectrum on the frequency axis before and after the shift in the same bands width before and after the shift, by interpolating or decimating audio data in the spectrum of the audio data shifted on the frequency axis by said frequency shift unit,
said inverse conversion unit, by converting audio data interpolated or decimated by said audio data interpolation unit to time-series audio data inversely, changing the reproduction pitch of audio data to be outputted based on said predetermined pitch changing amount,
said audio data output unit prolonging or reducing the reproduction time of audio data of which reproduction pitch is changed based on a changed clock signal supplied from said clock signal supplying unit.

6. The reproduction time changer according to claim 5, further comprising:
DAC (Digital Analog Converter) for converting digital audio data of time-series data obtained by said inverse conversion unit to analog audio data,
wherein said audio data output unit outputs analog audio data obtained by conversion by said DAC.

7. The reproduction time changer according to claim 5, wherein
said input audio data is compressed and stored as frequency data in a storage medium from which data can be read at any data reading speed.

8. The reproduction time changer according to claim 5, wherein
the reproduction time of the output audio data outputted by said audio data output unit is changed without changing the reproduction pitch of audio data to be outputted.

9. A digital signal processor incorporated in audio reproduction system for changing the reproduction pitch of audio data, comprising:
audio data input unit for inputting audio data compressed as frequency data;
inverse conversion unit which converts input audio data from frequency region to time region inversely to obtain time-series audio data and changes a reproduction pitch of said input audio data; and
audio data output unit which outputs audio data of which reproduction pitch is changed by said inverse conversion unit,
wherein said inverse conversion unit includes:
frequency shift unit which shifts the spectrum of said input audio data on the frequency axis based on a predetermined reproduction pitch changing amount of said input audio data and matches the band width of audio data after shift to the band width of said input audio data before the shift to obtain a reproduction frequency of time-series audio data to be outputted; and
audio data interpolation unit which equalizes the numbers of samples of audio data in the spectrum on the frequency axis before and after the shift in the same band width before and after the shift, by interpolating or decimating audio data in the spectrum of the audio data shifted on the frequency axis by said frequency shift unit,
said inverse conversion unit, by converting audio data interpolated or decimated by said audio data interpolation unit to time-series audio data inversely, changing the reproduction pitch of audio data to be outputted based on said predetermined pitch changing amount.

10. A digital signal processor incorporated in audio reproduction system for changing the reproduction time of audio data, comprising:
audio data input unit for inputting audio data compressed as frequency data;
inverse conversion unit which converts input audio data from frequency region to time region inversely to obtain time-series audio data and changes a reproduction pitch of said input audio data;
audio data output unit which outputs audio data of which reproduction time is changed;
clock frequency changer for changing the frequency of a clock signal based on a predetermined reproduction time changing amount of said input audio data; and
clock signal supplying unit for supplying a clock signal changed by said clock frequency changer to at least one or more of said inverse conversion unit and said audio data output unit,
wherein said inverse conversion unit includes:
frequency shift unit which shifts the spectrum of said input audio data on the frequency axis based on a predetermined reproduction time changing amount of said input audio data and matches the band width of audio data after shift to the band width of said input audio data before the shift to obtain a reproduction frequency of time-series audio data to be outputted; and
audio data interpolation unit which equalizes the numbers of samples of audio data in the spectrum on the frequency axis before and after the shift in the same band width before and after the shift, by interpolating or decimating audio data in the spectrum of the audio data shifted on the frequency axis by said frequency shift unit,
said inverse conversion unit, by converting audio data interpolated or decimated by said audio data interpolation unit to time-series audio data inversely, changing the reproduction pitch of audio data to be outputted based on said predetermined pitch changing amount,
said audio data output unit prolonging or reducing the reproduction time of audio data of which reproduction pitch is changed based on a changed clock signal supplied from said clock signal supplying unit.

11. A computer readable recording medium for causing a computer to execute a processing for changing the reproduction pitch of audio data arbitrarily, the processing comprising:
converting input audio data from frequency region to time region inversely to obtain time-series audio data and changing a reproduction pitch of said input audio data; and
outputting audio data of which reproduction pitch is changed by said inverse converting processing,
wherein said inverse converting processing includes:
shifting the spectrum of said input audio data on the frequency axis based on a predetermined reproduction pitch changing amount of said input audio data and matching the band width of audio data after shift to the band width of said input audio data before the shift to obtain a reproduction frequency of time-series audio data to be outputted; and
equalizing the numbers of samples of audio data in the spectrum on the frequency axis before and after the shift in the same bands width before and after the shift, by interpolating or decimating audio data in the spectrum of the audio data shifted on the frequency axis by said frequency shift processing,
said inverse converting processing, by converting audio data interpolated or decimated by said audio data interpolating processing to time-series audio data inversely, changing the reproduction pitch of audio data to be outputted based on said predetermined pitch changing amount.

12. A computer readable recording medium for causing a computer to execute a processing for changing the reproduction time of audio data arbitrarily, the processing comprising:
converting input audio data from frequency region to time region inversely to obtain time-series audio data and changing a reproduction pitch of said input audio data;
outputting audio data of which reproduction time is changed,
changing the frequency of a clock signal based on a predetermined reproduction time changing amount of said input audio data; and
supplying a clock signal changed by said clock frequency changing processing to at least one or more of said inverse converting processing and said audio data output processing,
wherein said inverse converting processing includes:
shifting the spectrum of said input audio data on the frequency axis based on a predetermined reproduction time changing amount of said input audio data and matching the band width of audio data after shift to the band width of said input audio data before the shift to obtain a reproduction frequency of time-series audio data to be outputted; and
equalizing the numbers of samples of audio data in the spectrum on the frequency axis before and after the shift in the same bands width before and after the shift, by interpolating or decimating audio data in the spectrum of the audio data shifted on the frequency axis by said frequency shift processing,
said inverse converting processing, by converting audio data interpolated or decimated by said audio data interpolating processing to time-series audio data inversely, changing the reproduction pitch of audio data to be outputted based on said predetermined pitch changing amount,
said audio data output processing prolonging or reducing the reproduction time of audio data of which reproduction pitch is changed based on a changed clock signal supplied from said clock signal supplying processing.

13. A computer program for causing a computer to execute a processing for changing the reproduction pitch of audio data arbitrarily, the processing comprising:
converting input audio data from frequency region to time region inversely to obtain time-series audio data and changing a reproduction pitch of said input audio data; and
outputting audio data of which reproduction pitch is changed by said inverse converting processing,
wherein said inverse converting processing includes:
shifting the spectrum of said input audio data on the frequency axis based on a predetermined reproduction pitch changing amount of said input audio data and matching the band width of audio data after shift to the band width of said input audio data before the shift to obtain a reproduction frequency of time-series audio data to be outputted; and
equalizing the numbers of samples of audio data in the spectrum on the frequency axis before and after the shift in the same bands width before and after the shift, by interpolating or decimating audio data in the spectrum of the audio data shifted on the frequency axis by said frequency shift processing,
said inverse converting processing, by converting audio data interpolated or decimated by said audio data interpolating processing to time-series audio data inversely, changing the reproduction pitch of audio data to be outputted based on said predetermined pitch changing amount.

14. A computer program for causing a computer to execute a processing for changing the reproduction time of audio data arbitrarily, the processing comprising:
converting input audio data from frequency region to time region inversely so as to obtain time-series audio data and changing a reproduction pitch of said input audio data;
outputting audio data whose reproduction time is changed;
changing the frequency of a clock signal based on a predetermined reproduction time changing amount of said input audio data; and
supplying a clock signal changed by said clock frequency changing processing to at least one or more of said inverse converting processing and said audio data output processing,
wherein said inverse converting processing includes:
shifting the spectrum of said input audio data on the frequency axis based on a predetermined reproduction time changing amount of said input audio data and matching the band width of audio data after shift to the band width of said input audio data before the shift to obtain a reproduction frequency of time-series audio data to be outputted; and
equalizing the numbers of samples of audio data in the spectrum on the frequency axis before and after the shift in the same bands width before and after the shift, by interpolating or decimating audio data in the spectrum of the audio data shifted on the frequency axis by said frequency shift processing,
said inverse converting processing, by converting audio data interpolated or decimated by said audio data interpolating processing to time-series audio data inversely, changing the reproduction pitch of audio data to be outputted based on said predetermined pitch changing amount,
said audio data output processing prolonging or reducing the reproduction time of audio data of which reproduction pitch is changed based on a changed clock signal supplied from said clock signal supplying processing.

15. A method of changing the reproduction pitch of audio data arbitrarily, comprising:
converting input audio data from frequency region to time region inversely to obtain time-series audio data and changing a reproduction pitch of said input audio data; and
outputting audio data of which reproduction pitch is changed by said inverse converting step,
wherein said inverse converting step includes:
shifting the spectrum of said input audio data on the frequency axis based on a predetermined reproduction pitch changing amount of said input audio data and matching the band width of audio data after shift to the band width of said input audio data before the shift to obtain a reproduction frequency of time-series audio data to be outputted; and
equalizing the numbers of samples of audio data in the spectrum on the frequency axis before and after the shift in the same bands width before and after the shift, by interpolating or decimating audio data in the spectrum of the audio data shifted on the frequency axis by said frequency shift step,
said inverse converting step, by converting audio data interpolated or decimated by said audio data interpolating step to time-series audio data inversely, changing the reproduction pitch of audio data to be outputted based on said predetermined pitch changing amount.

16. The method according to claim 15, further comprising:
converting digital audio data of time-series data obtained by said inverse converting step to analog audio data,
wherein said audio output step outputs analog audio data obtained by conversion by said DAC.

17. The method according to claim 15, wherein
said input audio data is compressed and stored as frequency data in a storage medium from which data can be read at any data reading speed.

18. A method of changing the reproduction time of audio data arbitrarily, comprising:
converting input audio data from frequency region to time region inversely to obtain time-series audio data and changing a reproduction pitch of said input audio data;
outputting audio data of which reproduction time is changed;
changing the frequency of a clock signal based on a predetermined reproduction time changing amount of said input audio data; and
supplying a clock signal changed by said clock frequency changing step to at least one or more of said inverse converting step and said audio data output step,
wherein said inverse converting step includes:
shifting the spectrum of said input audio data on the frequency axis based on a predetermined reproduction time changing amount of said input audio data and matching the band width of audio data after shift to the band width of said input audio data before the shift to obtain a reproduction frequency of time-series audio data to be outputted; and
equalizing the numbers of samples of audio data in the spectrum on the frequency axis before and after the shift in the same bands width before and after the shift, by interpolating or decimating audio data in the spectrum of the audio data shifted on the frequency axis by said frequency shift step,
said inverse converting step, by converting audio data interpolated or decimated by said audio data interpolating step to time-series audio data inversely, changing the reproduction pitch of audio data to be outputted based on said predetermined pitch changing amount,
said audio output processing prolonging or reducing the reproduction time of audio data of which reproduction pitch is changed based on a changed clock signal supplied from said clock signal supplying step.

19. The method according to claim 18, further comprising:
converting digital audio data of time-series data obtained by said inverse converting step to analog audio data with DAC (Digital Analog Converter),
wherein said audio output step outputs analog audio data obtained by conversion by said DAC.

20. The method according to claim 18, wherein
said input audio data is compressed and stored as frequency data in a storage medium from which data can be read at any data reading speed.
